(19) United States
(12) Patent Application Publication
(10) Pub. No.: US 2008/0090432 A1
(43) Pub. Date: Apr. 17, 2008

(54) Electrified ceiling framework underside connectors

(76) Inventors: Brian T. Patterson, Lewisberry, PA (US); Randy Marshall Manning, Lemoyne, PA (US); Jere W. Myers, Washington Boro, PA (US); Sandor Frecska, Mannington, WV (US)

Correspondence Address: John M. Olivo;Armstrong World Industries, inc., 2500 Columbia Avenue, P.O. Box 3001, Lancaster, PA, 17604-3001, US

(21) Appl. No.: 11/582,100

(22) Filed: Oct. 17, 2006

(51) Int. Cl. H01R 25/00

(52) U.S. Cl. 439/121

(57) ABSTRACT

An electrical connector for connecting low voltage device to an electrified ceiling framework. The connector includes a connector body and a conductive member attached to the connector body. The conductive member includes a contact portion configured to provide electrical contact to a conductive surface of the electrified ceiling framework. The connector is also configurable in a first position and a second position. The first position permits insertion of a portion of the connector into an opening in the electrified ceiling framework. The second position engages the electrified ceiling framework to provide an electrical connection and mechanical support to the connector and devices that may be attached thereto.

### FIELD OF THE INVENTION

The present invention is directed to connectors for making electrical connections between conductive elements and specifically for providing electrical connections to devices connectable from below a ceiling grid framework.

### BACKGROUND OF THE INVENTION

The electrical grid connecting America's power plants, transmission lines and substations to homes, businesses and factories operate almost entirely within the realm of high voltage alternating current (AC). Yet, an increasing fraction of devices found in those buildings actually operate on low voltage direct current (DC). Those devices include, but are not limited to, digital displays, remote controls, touch-sensitive controls, transmitters, receivers, timers, light emitting diodes (LEDs), audio amplifiers, microprocessors, and virtually all products utilizing rechargeable batteries.

Installation of devices utilizing low voltage DC has been typically limited to locations in which a pair of wires is routed from the voltage source. Increased versatility in placement and powering of low voltage DC components is desirable. Specifically, there is an increasing desire to have electrical functionality, such as power and signal transmission, in the ceiling environment without the drawbacks of known ceiling systems, including the drawback of pair wiring from the voltage source.

A conventional ceiling grid framework includes main grid elements running the length of the ceiling with cross grid elements therebetween. The main and cross elements form the ceiling into a grid of polygonal opening into which function devices, such as ceiling tiles, light fixtures, speakers and the like can be inserted and supported. The grid framework and ceiling tile system may provide a visual barrier between the living or working space and the infrastructure systems mounted overhead.

Known systems that provide electrification to ceiling components, such as lighting, utilize mounting cable trays and electrical junctions in the plenum space above the ceiling grid framework. These known systems suffer from the drawback that the complex network of wires occupy the limited space above the ceiling grid, and are difficult to service or reconfigure.

In known systems utilizing track systems, the connecting devices have terminals that provide electrical connections to conductors provided in a track. These tracks have the drawbacks that they typically require wiring and mechanical support from the plenum space above the ceiling grid framework. In addition, the track systems are typically viewable from the room space and are aesthetically undesirable. Further still, known track systems typically utilize higher voltage AC power and connect to AC powered devices, requiring specialized installation and maintenance.

What is needed is a ceiling system that provides low voltage power connections that can be accessed from below the plane of the grid framework without the drawbacks of known ceiling systems. The present invention accomplishes these needs and provides additional advantages.

### SUMMARY OF THE INVENTION

An electrical connector for connecting low voltage device to an electrified ceiling framework is provided. The connector includes a connector body and a conductive member attached to the connector body. The conductive member includes a compliant biased contact portion configured to provide electrical contact to a conductive surface of the electrified ceiling framework. The conductive member may be rotatably mounted to the connector body or the conductive member may be retractably extendable in a direction from the connector body.

Another aspect of the invention includes a connector that is configurable in a first position and a second position. The first position permits insertion of a portion of the connector into an opening in the electrified ceiling framework. The second position engages the electrified ceiling framework to provide an electrical connection and mechanical support to the connector and devices that may be attached thereto.

Still another aspect of the invention includes a method for providing electrical power to a low voltage device from an electrified ceiling framework. An electrified ceiling framework is provided having a box portion comprising an opening. The box portion further comprises at least one conductive material in electrical connection with a low voltage power source. A connector body is also provided having a conductive member rotatably attached thereto. The conductive member includes a contact portion configured to provide electrical contact to a conductive surface of the electrified ceiling framework. A portion of the connector body is inserted into the opening in the box portion of the electrified ceiling framework. The conductive member is rotated to provide electrical contact with the conductive material. The rotation may also engage one or more of the surfaces of the electrified ceiling framework to provide mechanical support to the connector and devices that may be attached thereto.

An advantage of the electrical connectors of the present invention is the suitable electrical contact achieved via rotation of the connector. Mechanical bias of the connector may be utilized to further improve the physical and/or electrical contact.

Another advantage of the electrical connector of the present invention is the removal and/or penetration of dust, dirt and/or oxide that may be present on electrical conductors to be contacted.

Still another advantage of the electrical connector of the present invention is the flexibility in locating the positive and negative polarity conductive surfaces in order to allow connection to a greater variety of low voltage devices.

Still another advantage of the electrical connector of the present invention is that connector may support the weight of electrical devices via a mechanical interlock with a ceiling support member.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 shows a perspective view of a room space having an electrified ceiling according to an embodiment of the present invention.

FIG. 2 shows a perspective view of a section of grid framework according to an embodiment of the invention.

FIG. 3 shows an elevational perspective view of a connector arrangement in connection with a low voltage device according to an embodiment of the present invention.

FIG. 4 shows an elevational perspective view of a connector according to an embodiment of the present invention.

FIG. 5 shows an elevational perspective view of the connector of FIG. 4 with a conductive member in an alternate position according to the present invention.

FIG. 6 shows an elevational perspective view of a connector according to an embodiment of the present invention.

FIG. 7 shows a cutaway elevational view of an embodiment of a connector according to the present invention.

FIG. 8 shows a cutaway elevational view of an alternate embodiment of a connector and support member according to the present invention.

FIG. 9 shows an elevational cutaway view of another embodiment of a connector according to the present invention.

FIG. 10 shows an elevational cutaway view of another embodiment of a connector according to the present invention.

FIG. 11 shows an elevational cutaway view of still another embodiment of a connector according to the present invention.

FIG. 12 shows an elevational cutaway view of still another embodiment of a connector according to the present invention.

Wherever possible, the same reference numbers will be used throughout the drawings to refer to the same or like parts.

### DETAILED DESCRIPTION OF THE INVENTION

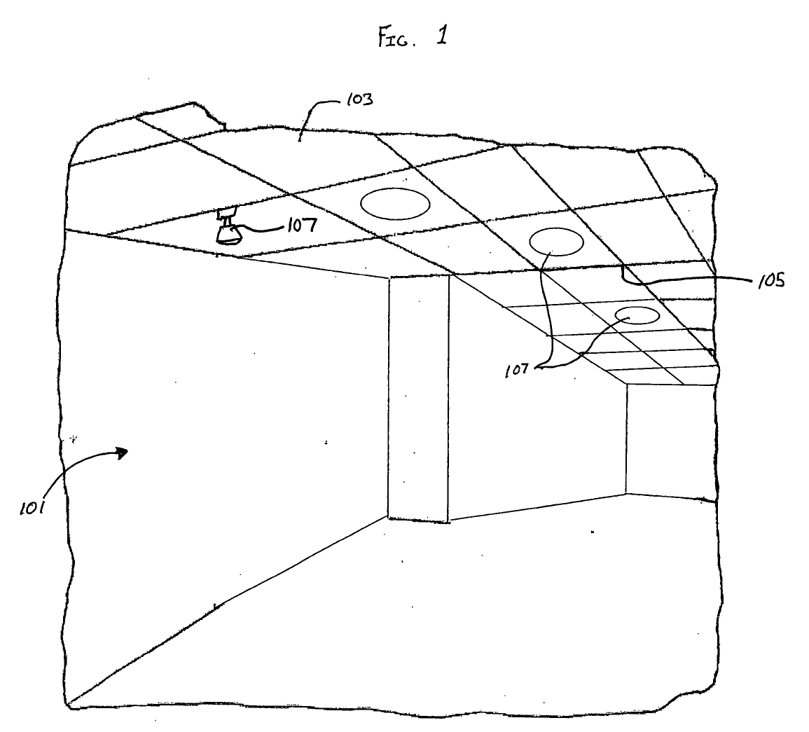

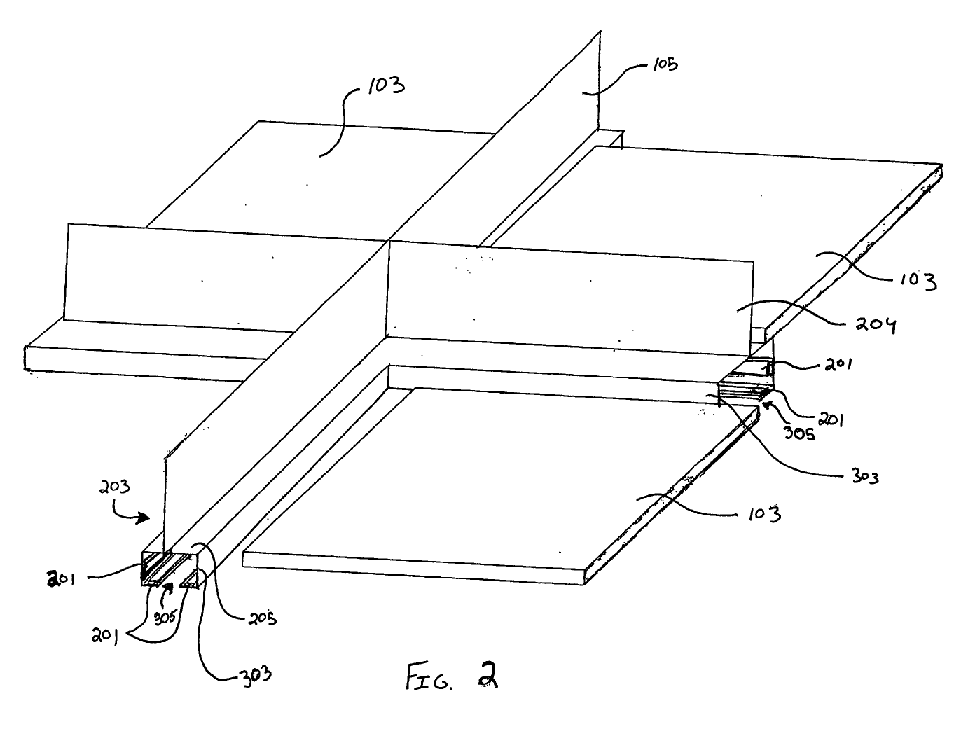

The present invention includes connectors for use with an electrified ceiling. FIG. 1 shows a room space 101 having a ceiling 103 supported by a ceiling grid framework 105. The ceiling 103 may include decorative tiles, acoustical tiles, insulative tiles, lights, heating ventilation and air conditioning (HVAC) vents, other ceiling elements or covers and combinations thereof. Low voltage devices 107, such as light emitting diode (LED) lights, speakers, smoke or carbon monoxide detectors, wireless access points, still or video cameras, or other low voltage devices, may be utilized with the electrified ceiling. Power for the low voltage devices 107 is provided by conductors 201 (see FIG. 2) placed upon ceiling grid framework 105.

FIG. 2 shows a perspective view of a segment of the ceiling grid framework 105 viewed from above with a portion of the ceiling 103 removed. The ceiling grid framework 105 includes intersecting support members 203 having a lower box 303. Lower box 303 includes surfaces onto which conductors 201 are placed. The geometry of lower box 303 is not limited to the geometry shown and may include alternate shapes having surfaces onto which conductors 201 may be disposed. For example, the lower box may be configured into a cross-section having a rounded geometry, a rectangular geometry, a trapezoidal geometry or any other geometry capable of supporting ceiling 103 and providing interior surfaces suitable for receiving conductors 201. The support members 203 further include webbing 204 extending from lower box 303, which may be attached to the building structure by use of wires or other suitable support device connected to the building structure (not shown in FIG. 2).

Conductors 201 are mounted onto surfaces with lower box 303. However, the conductors 201 may be mounted on other surfaces, including any surfaces that may be electrically connected to electrical devices, including, but not limited to the vertical surfaces and lower flanges surfaces opposite the flange surfaces 205. The conductors 201 comprise a conductive material that, when contacted, provides an electrical connection that is sufficient to power a low voltage electrical device. Suitable conductive materials include, but are not limited to, aluminum and its alloys, copper and its alloys, brass, phosphor bronze, beryllium copper, stainless steel, or other conductive material or combinations thereof. In addition, conductive materials may include a plating including, but not limited to, nickel, tin, lead, bismuth, silver, gold plating or other conductive material plating or combination thereof.

As shown in FIG. 2, suitable surfaces for receiving conductors 201 include, but are not limited to, horizontal and vertical interior surfaces of lower box 303 of support member 203. The conductors 201 may have a positive polarity or a negative polarity. Conductors 201 having a positive or negative polarity may be disposed in locations that permit completion of an electrical circuit when connectors 310 (not shown in FIG. 2) are positioned. The conductors 201 may be exposed to the atmosphere, or may be partially or fully coated by a conductive or non-conductive material or protective coating. Conductors 201 may be mounted onto the ceiling grid framework 105 by any suitable method, including, but not limited to, adhesive or mechanical connection. In addition, the conductors 201 may be mounted directly onto the surface of the ceiling grid framework 105 or may have insulating material, such as MYLAR®, between the conductors 201 and the ceiling grid framework 105. MYLAR® is a federally registered trademark of E.I. Du Pont De Nemours and Company Corporation, Wilmington, Del., having a polyester composition that is well known in the art. Additional suitable insulative materials include, but are not limited to, polyester, acrylic, polyurethane, polyvinyl, silicone, epoxy, or other insulative compositions, or combinations thereof. Ceiling 103 may include conventionally available components, such as ceiling tiles that may be placed directly onto the conductors 201. In a preferred embodiment, the ceiling 103 includes ceiling tiles fabricated from an insulative material, such as paperboard.

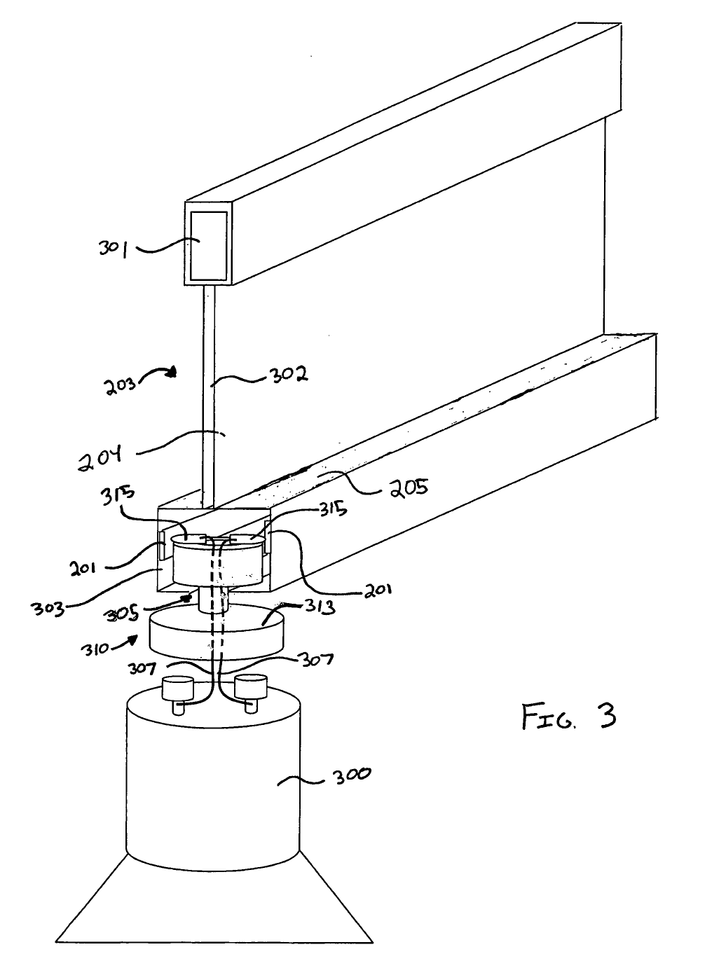

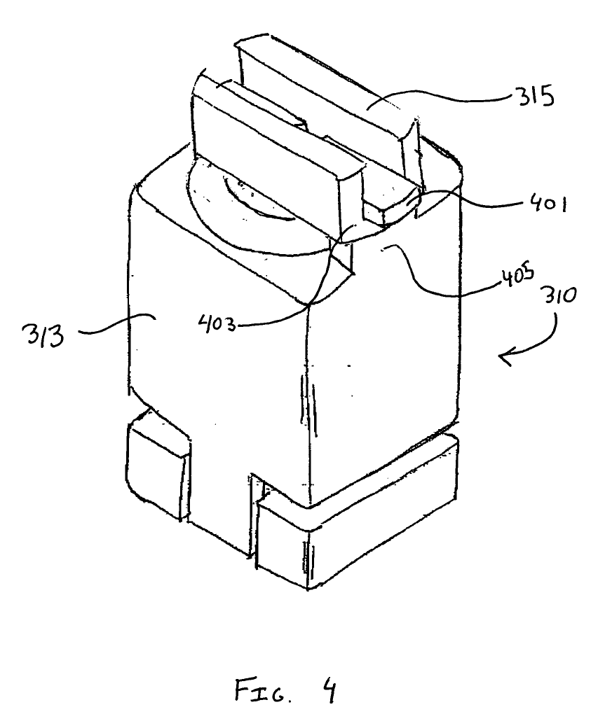

FIG. 3 shows perspective view of a portion of a support member 203 having an alternate geometry to the support member 203 shown in FIG. 2 electrically connected to an electrical device 300. The support member 203 in FIG. 3 includes an upper box or bulb 301 and a webbing 204 extending to a lower flange surface 205. Electrical device 300 is powered by a pair of wires 307 in electrical contact with conductors 201 by way of connector 310. Wires 307 are electrically connected to conductive members 315. Conductive members 315 are rotatably mounted on connector body 313 and provide support to connector 310. The arrangement of conductive member 315 is not limited to the arrangement shown in FIG. 3, but may include unitary conductive material rotatably attached to the connector body 313, or the conductive member 315 may include conductive portion 401 (see FIG. 4) and a non-conductive portion 403 (see FIG. 4) rotatably attached to the connector body 313.

In an example of the present invention supportive non-conductive portion 403 includes at least part of the conductive member 315 of the connector 310, wherein the non-conductive portion 403 preferably is disposed upon surfaces of lower box 303 to provide mechanical support for devices, such as electrical device 300, that may be attached to connector 310. Mechanical support includes an ability to carry or bear weight or force. Suitable conductive materials for use with conductive member 315 include, but are not limited to, aluminum and its alloys, copper and its alloys, brass, phosphor bronze, beryllium copper, stainless steel, or other conductive material or combinations thereof. In addition, conductive materials may include a plating including, but not limited to, nickel, tin, lead, bismuth, silver, gold plating or other conductive material plating or combination thereof. Non-conductive materials for use with the conductive member 315 may include polymers, such as nylon or polyester, or ceramics, such as glass or refractory material.

Connector 310 provides an electrical connection via a physical contact between the conductive member 315 and at least one conductor 201. The conductive member 315 is preferably further in electrical communication with a wire or electrical device capable of forming an electrical circuit with conductor 201 to power a device such as electrical device 300. The conductive member 315 preferably includes a mechanical bias. Mechanical bias is a force provided on a surface, particularly a force establishing and/or maintaining an electrical connection. Mechanical bias is preferably from the material properties of the conductive member 315 to provide continuous physical contact between the conductive member 315 and conductor 201, via elasticity of the material, material memory, by weight of the connector 310, or by any other force providing means in order to contact and retain contact with the conductor 201.

In another embodiment of the present invention, the connector 310 is integrated into an electrical device 300. In this embodiment of the present invention, the integrated connector 310 both provides power to the device 300 and mechanically supports the device.

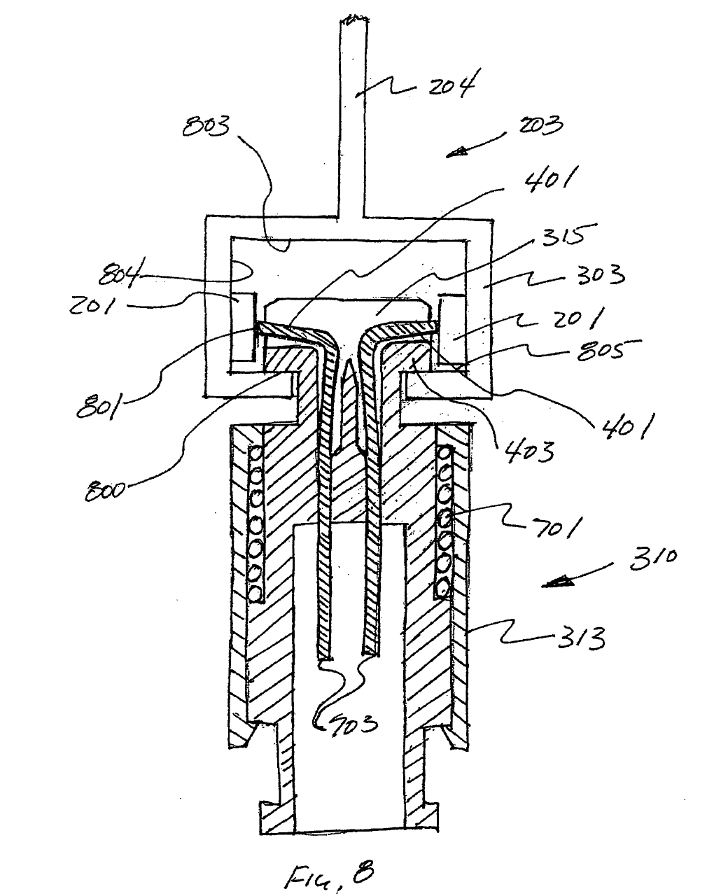

The conductive member 315 of connector 310 is preferably configured to be capable of insertion into opening 305 in a first position, and in electrical communication with conductors 201 and preferably resting upon a surface of lower box 303 in a second position. While being placed into the second position, the conductive member 315 rotates and contacts one or more conductors 201 and provides a rotational motion across the surface of the conductor 201 to provide sufficient physical contact to form an electrical connection. The wiping and scraping of the rotational motion preferably displaces any dirt, dust, oxide or non-conductive or protective coating that may be present on the contact surface 801 (see FIG. 8) of the conductor 201.

FIG. 4 shows an arrangement of connector 310 according to an embodiment of the present invention in a first position. As shown in FIG. 4, the conductive member 315 is rotatably mounted on connector body 313. The conductive member 315 includes a conductive portion 401 fabricated from a conductive material and a non-conductive portion 405 fabricated from a non-conductive material. The conductive portion 401 preferably includes a protrusion extending from the conductive member 315 in a direction that provides contact with conductors 201 when engaged with the support member 203. In the first position, illustrated by FIG. 4, the conductive member 315 is adjacent to tab 405, providing a cross-section of the upper portion of the connector 310 that corresponds to the geometry of opening 305 to allow insertion of the conductive member 315 into opening 305. The geometry of connector 310 is not limited to the geometry shown in FIG. 4 and may include, but is not limited to, geometries including elongated rectangular geometries, cylindrical geometries, frustoconical geometries, trapezoidal geometries, and any other geometries that permit support of a rotatable conductive member 315.

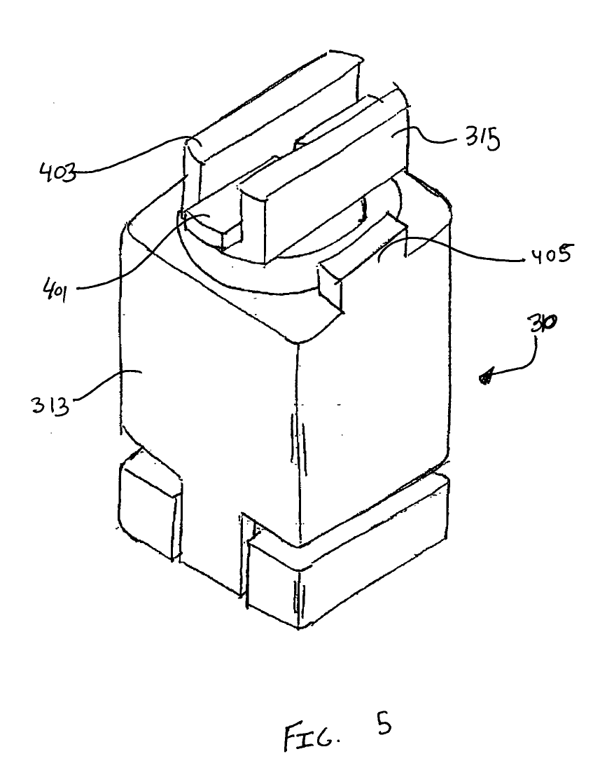

FIG. 5 illustrates the connector 310 of FIG. 4 in a second position. The conductive member 315 is positioned such that the non-conductive portion 403 engages a surface of the lower box 303 and provides support for connector 310 and any devices that may be attached thereto. In addition, in the second position, the conductive portion 401 is rotated into a position that contacts conductors 201 (not shown in FIG. 5).

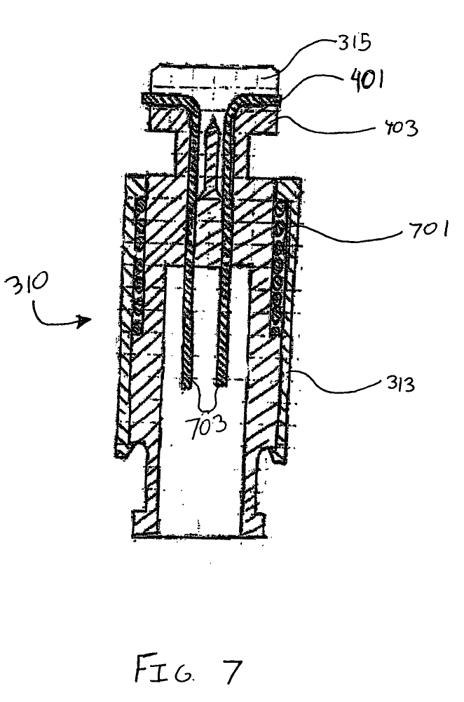

In another embodiment of the invention, the connector 310 may have the arrangement shown in FIG. 5, wherein the conductive member 315 retractably extends in a direction from connector body 313. This embodiment may include a rotatable conductive member 315 or a conductive member 315 that does not rotate with respect to the connector body 313. The retractable extension of the conductive member 315 is accomplished by use of a spring 701 (see FIG. 7) or other force-providing device mounted within the connector body 313. The extension is sufficient to create a geometry that is insertable into the lower box 303 in a manner that provides engagement with at least one surface of the lower box and electrical contact with conductors 201. In one embodiment, the extension includes a movement away from the connector body 313, wherein the connector 310 is inserted into the lower box 303 and rotated and permitted to retract in a direction toward the connector body. Preferably the tabs 405 align within opening 305 wherein the retraction of the conductive member 315 acts to position and engage the tabs within the opening 305. The rotation and retraction provide mechanical engagement of the connector 310 with at least one surface of the lower box 303 and electrical connection via a wiping or scraping rotational movement on conductors 201.

Although the connector 310 has been shown and described as having a rotatably conductive member 315 and a retractably extendable conductive member 315, any geometry or manner of attachment between the conductive member 315 may be utilized that allows engagement of the conductive member 315 with at least one surface of the lower box 303 and provides electrical connection to conductors 201.

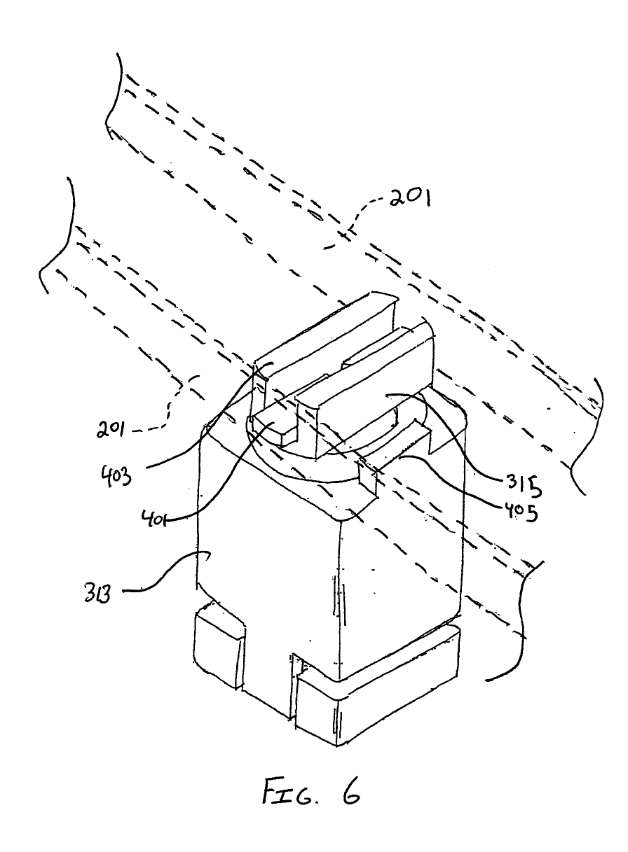

FIG. 6 illustrates a connector 310 in electrical contact with conductors 201. As shown in FIG. 6, the conductive member 315 preferably rotates about an axis with respect to the connector body 313 that provides a wiping or scraping contact with conductors 201. In one embodiment of the present invention, the conductive portion 401 may include a mechanical bias to provide compliant contact force between conductive portion 401 and conductor 201. By mechanically biased, it is meant that the conductive portion 401 may be configured to provide continuous physical contact between the conductive portion 401 and conductor 201 via elasticity of the material, geometry of the material, by weight and configuration of the connector 310, or by any other force providing means in order to contact and retain contact with the conductor 201.

FIG. 7 illustrates a cutaway elevation view of a connector 310 according to an embodiment of the invention. Connector 310 includes conductive member 315 having a conductive portion 401 and a non-conductive portion 403. The conductive member 315 is arranged to rotate within connector body 313. Rotation of the conductive member 315 within connector body 313 may take place using any suitable arrangement that provides rotation of conductive member 315. Spring 701 provides a force urging the conductive member 315 in a direction toward the connector body 313 and permits rotation of the conductive member 315. Although spring 701 is shown as a coil utilizing elastic material properties to provide force, any force providing device may also be used. For example, threaded screw arrangements, retaining pins, clips, or any other force providing device may be used. However, while FIGS. 7-12 show a force-providing device (e.g., spring 701), connector 310 does not require the presence of a force-providing device. As shown, the conductive portion 401 extends into the connector 310 to wire connections 703. Wire connections 703 provide conductive surfaces suitable for connection to an electrical connector, particularly an electrical connector powering a low voltage device. The wire connections may be connected to an electrical device 300 by any known device, including, but not limited to clips, plugs, screws, solder or any other known electrical connection.

FIG. 8 shows connector 310 of FIG. 7 positioned within lower box 303 of support member 203. Lower box 303 includes an upper horizontal surface 803, a side vertical surface 804 and a lower horizontal surface 805. In the embodiment shown in FIG. 8, conductors 201 are disposed on side vertical surfaces 804. Non-conductive portion 403 is engaged with the lower surface 800 of lower box 303. The engagement of the non-conductive portion 403 provides sufficient support to retain the connector 310 in position and to support any device 300 that may be attached thereto. Spring 701 may also provide additional clipping support between connector 310 and support member 203. In addition conductive portion 401 has a portion that protrudes in a direction away from the conductive member 215 and is engaged with contact surface 801 of conductor 201. The conductive portion 401 is preferably in sufficient contact with conductor 201 to provide an electrical connection to power an electrical device 300 electrically connected to wire connections 703. Furthermore, conductive portion 401 is biased to provide compliant contact force with conductor 201. Conductive portion 401 may be configured as a cantilever beam, simply supported beam, torsion bar or the bias may be provide by another spring such as a helical compression spring or torsion spring.

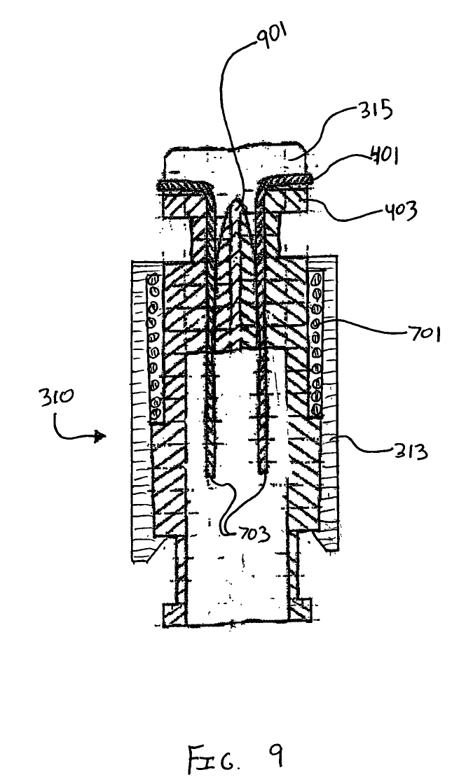

FIG. 9 shows an alternate embodiment of connector 310. Connector 310 includes the conductive member 315, conductive portion 401, non-conductive portion 403, spring 701, connector body 313 and wire connections 703 shown and described with respect to FIG. 7. In this embodiment, the conductive portion 401 is configured to deflect in a direction toward an insert 901. Insert 901 preferably has a geometry that permits deflection via material elasticity of conductive portion 401 while maintaining contact with conductor 201. The conductive portion 401 may deflect in a manner that conforms to the geometry of the surface of insert 901 to provide a surface onto which the deflection is halted and additional deflection of the conductive portion 401 is prevented. The controlled deflection via insert 901 permits repeated deflection of the conductive portion 401, while providing sufficient, repeatable electrical contact with conductor 201.

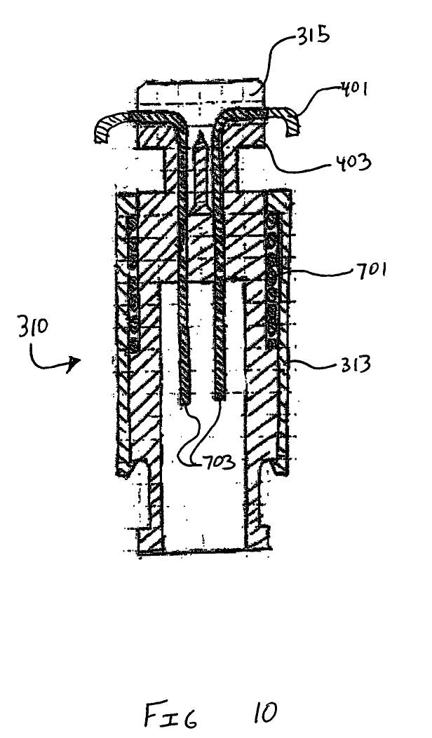

FIG. 10 shows an alternate embodiment of connector 310. Connector 310 includes the conductive member 315, conductive portion 401, non-conductive portion 403, spring 701, connector body 313 and wire connections 703 shown and described with respect to FIG. 7. In this embodiment, the conductive portion 401 is configured to provide contact to a conductor 201 located on a lower horizontal surface 805 (see FIG. 8) of lower box 303. The arrangement of FIG. 10 provides the wiping or scraping motion of the rotation of the conductive member 315, while additional providing an additional force from the weight of the connector 310, the weight of the electrical device 300 (see FIG. 3) and the bias of spring 701 onto conductor 201 when the connector 310 is engaged into position within lower box 303 of support member 203.

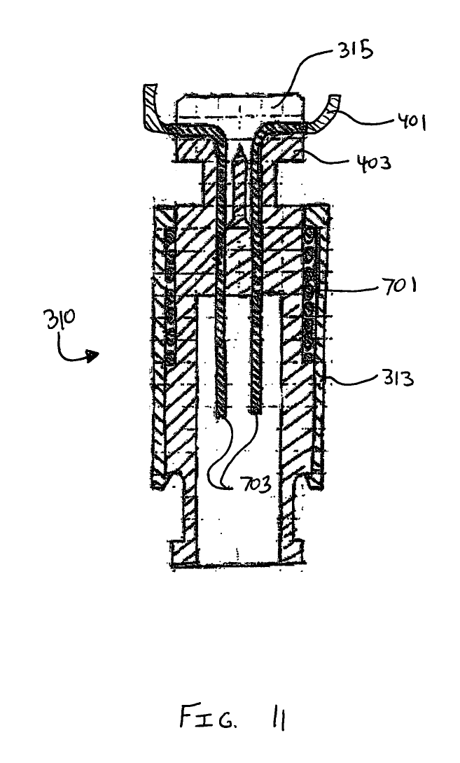

FIG. 11 shows an alternate embodiment of connector 310. Connector 310 includes the conductive member 315, conductive portion 401, non-conductive portion 403, spring 701, connector body 313 and wire connections 703 shown and described with respect to FIG. 7. In this embodiment, the conductive portion 401 is configured with a protrusion to provide contact to a conductor 201 located on an upper horizontal surface 803 (see FIG. 8) of lower box 303. The arrangement of FIG. 11 provides the wiping or scraping motion of the rotation of the conductive member 315, while additionally allowing electrical contact with conductors 201 positioned on the upper horizontal surfaces of the lower box 303. Providing conductors 201 on the upper horizontal surfaces of the lower box 303 permits the conductors 201 to be located in alternate locations within lower box 303, which may provide configurations that are more easily fabricated or retrofitted.

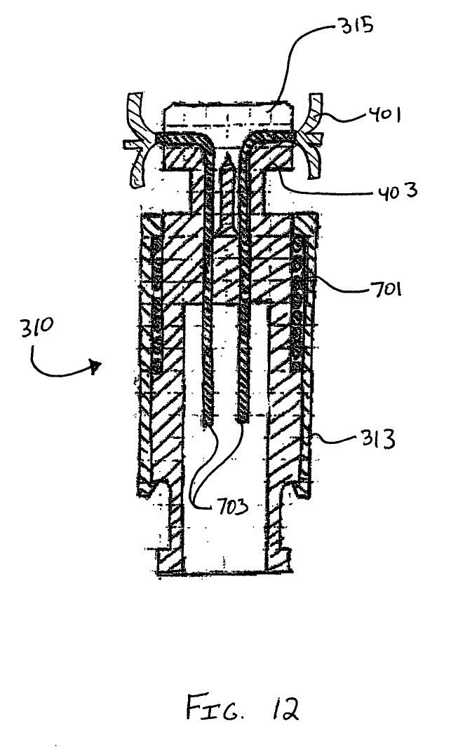

FIG. 12 shows an alternate embodiment of connector 310. Connector 310 includes the conductive member 315, conductive portion 401, non-conductive portion 403, spring 701, connector body 313 and wire connections 703 shown and described with respect to FIG. 7. In this embodiment, the conductive portion 401 is configured with a protrusion to provide contact to a conductor 201 located on the upper horizontal surface 803, side vertical surface 804 and lower horizontal surface 805 or any combination thereof. The configuration shown in FIG. 12 provides additional surfaces of conductive portion 401 which may contact the conductors 201, increasing the sufficiency of the electrical contact, and may allow alternate configurations of conductors 201 within lower box 303 to allow easier fabrication, retrofit or installation of connector 310 into a variety of differently configured support members 203.

Connectors 310 according to the present invention may be used alone or in combination with additional connectors 310. Systems may also provide connectors 310 to provide mechanical support for devices 300, such as monitor screens, conference tables, light fixtures or other low voltage devices, wherein power for the device 300 is provided by additional connectors 310.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An electrical connector for connecting low voltage device to an electrified ceiling framework, comprising:
a connector body; and
a conductive member rotatably attached to the connector body, the conductive member including a conductive portion having a compliant bias configured to provide electrical contact to a conductive surface of the electrified ceiling framework.

2. (canceled)

3. The electrical connector of claim 1, wherein the conductive member retractably extends in a direction from the connector body.

4. (canceled)

5. The electrical connector of claim 1, wherein the conductive portion is capable of displacing oxide, dirt or dust on the conductive surface of the electrified ceiling framework.

6. The electrical connector of claim 1, wherein the conductive portion extends in a single direction.

7. The electrical connector of claim 1, wherein the conductive portion extends in a plurality of directions.

8. The electrical connector of claim 1, wherein the connector is integrated within an electrical device.

9. The electrical connector of claim 1, wherein the connector further comprises wiring contacts for attachment to electrical devices.

10. The electrical connector of claim 1, wherein the conductive member comprises a material selected from the group consisting of aluminum, copper, brass, phosphor bronze, beryllium copper, stainless steel, gold plating, tin plating, nickel plating, silver plating and combinations thereof.

11. The electrical connector of claim 1, wherein the conductive member includes a non-conductive portion.

12. The electrical connector of claim 11, wherein the non-conductive portion is configured to engage at least one surface of the electrified ceiling framework.

13. The electrical connector of claim 12, wherein the non-conductive portion provides sufficient engagement to support an electrical device.

14. The electrical connector of claim 1, wherein the conductive portion having compliant bias is configured with mechanical bias to provide additional force during contact with the conductive surface of an electrified ceiling framework.

15. An electrical connector for connecting low voltage device to an electrified ceiling framework comprising:
a connector body; and
a conductive member rotatably attached to the connector body, the conductive member being configurable into a first and a second position with respect to the connector body,
wherein the first position provides the conductive member with geometry that is insertable into an opening in the electrified ceiling framework; and
wherein the second position engages at least one surface of the electrified ceiling framework.

16. An electrified ceiling framework system comprising:
an electrified ceiling framework comprising a conductive surface;
a connector adjacent to at least a portion of the conductive surface, the connector comprising:
a connector body; and
a conductive member rotatably attached to the connector body, the conductive member having a conductive portion configured to provide electrical contact to the conductive surface of the electrified ceiling framework.

17. (canceled)

18. The electrical connector of claim 16, wherein the conductive member retractably extends in a direction from the connector body.

19. (canceled)

20. The system of claim 16, wherein the conductive portion is capable of displacing oxide, dirt or dust on the conductive surface of the electrified ceiling framework.

21. The system of claim 16, wherein the conductive portion extends in a single direction.

22. The system of claim 16, wherein the conductive portion extends in a plurality of directions.

23. The system of claim 16, wherein the connector is integrated within an electrical device.

24. The system of claim 16, wherein the connector further comprises wiring contacts for attachment to electrical devices.

25. The system of claim 16, wherein the conductive member comprises a material selected from the group consisting of aluminum, copper, brass, phosphor bronze, beryllium copper, stainless steel, gold plating, tin plating, nickel plating, silver plating or combinations thereof.

26. The system of claim 16, wherein the conductive member includes a non-conductive portion.

27. The system of claim 26, wherein the non-conductive portion is configured to engage at least one surface of the electrified ceiling framework.

28. The system of claim 26, wherein the non-conductive portion provides sufficient engagement to support an electrical device.

29. The system of claim 16, wherein the conductive portion having compliant bias is configured with mechanical bias to provide additional force during contact with the conductive surface.
